(19) United States
(12) Patent Application Publication
(10) Pub. No.: US 2018/0007563 A1
(43) Pub. Date: Jan. 4, 2018

(54) Idle Mode Operation in the Heterogeneous Network with Conventional Macro Cell and MMW Small Cell

(71) Applicant: MEDIATEK Singapore Pte. Ltd., Singapore (SG)

(72) Inventors: Yuanyuan Zhang, Beijing (CN); Yu-Syuan Jheng, Taipei City (TW); Aimin Justin Sang, San Diego, CA (US)

(21) Appl. No.: 15/689,189

(22) Filed: Aug. 29, 2017

Related U.S. Application Data
(63) Continuation of application No. PCT/CN2015/078005, filed on Apr. 30, 2015.

(51) Int. Cl. H04W 16/32; H04W 68/02; H04W 76/04; H04W 68/04

(52) U.S. Cl. CPC H04W 16/32; H04W 76/046; H04W 68/02; H04W 68/04

(57) ABSTRACT

Apparatus and methods are provided to handle idle mode operation in the heterogeneous network with conventional macro cell and millimeter wave (mmW) small cells. In one novel aspect, the UE camps on both the macro cell and the mmW small cell. The UE receives system information that includes information of mmW small cells and paging messages from the macro cell and establishes RRC connection with one of the mmW small cell. In one embodiment, the UE performs mmW small cell discovery upon obtaining mmW small cell information. In another embodiment, the UE performs the mmW small cell discovery if the mobility status indicates low mobility and/or the traffic type is suitable for the mmW small cell. In another novel aspect, the UE receives the paging request from the macro cell and sends the paging response to the mmW small cell base station who forwards the paging response to the MME.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2015/078005, with an international filing date of Apr. 30, 2015. This application is a continuation of International Application No. PCT/CN2015/078005, which is pending as of the filing date of this application, and the United States is a designated state in International Application No. PCT/CN2015/078005. The disclosure of each of the foregoing documents is incorporated herein by reference.

### TECHNICAL FIELD

The disclosed embodiments relate generally to wireless communication, and, more particularly, to idle mode operation in the heterogeneous network with conventional macro cell and millimeter wave (mmW) cell.

### BACKGROUND

The bandwidth shortage increasingly experienced by mobile carriers has motivated the exploration of the underutilized millimeter wave (mmW) frequency spectrum between 6G and 300G Hz for the next generation broadband cellular communication networks. The available spectrum of mmW band is two hundred times greater than the conventional cellular system. The mmW wireless network uses directional communications with narrow beams and can support multi-gigabit data rate. The underutilized bandwidth of the mmW spectrum has wavelengths ranging from 1 mm to 100 mm. The very small wavelengths of the mmW spectrum enable large number of miniaturized antennas to be placed in a small area. Such miniaturized antenna system can produce high beamforming gains through electrically steerable arrays generate directional transmissions.

With recent advances in mmW semiconductor circuitry, mmW wireless system has become a promising solution for the real implementation. However, the heavy reliance on directional transmissions and the vulnerability of the propagation environment present particular challenges for the mmW network. For example, mmW channel changes much faster than today's cellular system due to the small coherence time, which is about hundreds of microsecond. The mmW communication depends extensively on adaptive beamforming at a scale that far exceeds current cellular system. Further, the high reliance on the directional transmission introduces new issues for synchronization. Broadcast signals may delay the base station detection during cell search for initial connection setup and for handover because both the base station and the mobile station need to scan over a range of angles before the mobile station can detect the base station. Furthermore, mmW signals are extremely susceptible to shadowing. The appearance of obstacles, such as human bodies and outdoor materials would cause the signal outage. The small coverage of the cell causes the relative path loss and the cell association to change rapidly.

The unreliability of the mmW small cell creates a problem for paging process because potential large number of retransmissions are required for the paging message to reach the UE. Further, the frequent handover for UE with high mobility also creates large network overhead and degrades the UE battery life.

With similar mechanism as current IDLE mode operation, when the UE is in the idle mode, the UE can camp on the macro cell or the mmW small cell if the mmW base station is standalone and UE can access the network through it. No matter UE camps on the conventional macro cell or the mmW small cell, both operations may cause potential problems. When the UE camps on the cellular macro cell, it receives system information (SI), paging from the macro cell. The UE can initiate access to the network through the macro cell if it wished to establish a radio resource control (RRC) connection, such as for mobile originating (MO) call or mobile terminating (MT) call. The mmW resources are aggregated by the macro cell to provide extremely high data rate for the UE. Then the macro eNB can be considered as the Master eNB and the mmW base station is considered as the Secondary eNB. Considering the extremely high requirement of connection density in 5G such as 1 million connections per square kilometer, anchoring all the UEs to the macro eNB would pose a challenge to the capabilities of the macro eNB and the backhaul to core network. Because the macro eNB needs to manage so many UEs, maintain so many connections, reserve the corresponding radio resources and process large volume of traffic for the UEs. When UE moves between the mmW small cells, it will introduce large signaling traffic on the interface between base stations and the interface between the base station and the core network, e.g. SGW. In order to relieve the challenges to macro base station, it would be better to offload the UE connections to the mmW base station. One method is to move the UE to the mmW base station through handover. However, handover procedure is of very high cost, which will involve large signaling overhead, long time of transmission interruption and power consumption. In alternative, the UE connections can be offloaded to the mmW base station initially in the IDLE mode, so UE can initiates access to the network through the mmW base station. However, the characteristics of the mmW small cell degrade the performance of paging process. The high directional beamforming can't provide uniform transmission for paging message across a range of deployment. So paging message needs to be transmitted repeatedly over a potentially large angular directional space. Due to the small coverage of the MMW small cell, one TA will have large amount of small cells in the ultra dense network, which have to transmit the paging message for the UE. It will introduce large amount of signaling overhead, which is not efficient for network. MMW is sensitive to blockages and suffer from severe penetration loss through solid materials. Hence, the range of LOS is limited by the presence of obstructions. NLOS path loss is more relevant to the environment factors, such as the density of scatters, and is consistently larger than the LOS. It will affect the reachability and retainability of the paging message. Considering those problems, improvements and enhancements are required for idle mode UE in the heterogeneous network with the conventional cellular cells and the mmW small cells.

### SUMMARY

Apparatus and methods are provided to proform idle mode operation in the heterogeneous network with conventional macro cell and millimeter wave (mmW) small cells, especially in the ultra dense network with extremely high connection density. In one novel aspect, the UE camps on both the macro cell and the mmW small cell. The UE receives system information that includes information relevant to mmW small cells and paging messages from the macro cell and establishes a RRC connection with one of the mmW small cells. In one embodiment, the UE performs mmW small cell discovery upon obtaining the mmW small cell information. In another embodiment, the UE performs the mmW small cell discovery if the mobility status indicates low mobility and/or the traffic type is suitable for the mmW small cell. In yet another embodiment, the service type of the application is determined before the UE performs the mmW small cell discovery. In other embodiments, the QoS requirement of the service such as the latency, the data rate and the data volume are considered in selecting an access network to establish the RRC connection. In one embodiment, the paging message indicates if an mmW small cell is preferred for a MT call. In another embodiment, the macro cell is preferred for MO signaling.

In another novel aspect, the UE selects the mmW small cell for the RRC connection and indicates the connection is paged by the macro eNB in the RRCConnectionRequest message sent to the mmW small cell eNB. The mmW small cell eNB upon establishing the RRC connection with the UE after receiving such request sends a RRC connection setupsetup message (eg through X2AP message UE context setup message) to the macro eNB. In one embodiment, the macro eNB stops paging the UE upon receiving the RRC established message from the mmW eNB. The macro eNB sends an acknowledgement to the mmW eNB. In one embodiment, the macro eNB sends a paging response to the MME. In an alternative embodiment, the mmW eNB sends the paging response to the MME.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless communication network with mmW connections in accordance with embodiments of the current invention.

FIG. 2 shows an exemplary block diagram for the UEs to receive system information and paging messages from the macro eNB and establish RRC connection with the mmW base station in accordance with embodiments of the current invention.

FIG. 3 shows an exemplary flow chart of idle mode operation for mobile stations in the heterogeneous network in accordance with embodiments of the current invention.

FIG. 4 illustrates an exemplary flow chart of the UE performing idle mode connection establishment in the heterogeneous network in accordance with embodiments of the current invention.

FIG. 5 illustrates an exemplary flow chart of the UE performing MT call in the heterogeneous network in accordance with embodiments of the current invention.

FIG. 6 illustrates an exemplary flow chart of the UE performing MO call in the heterogeneous network in accordance with embodiments of the current invention.

FIG. 7 is an exemplary message diagram for the network to support the idle UE action in the heterogeneous network in accordance with embodiments of the current invention.

FIG. 8 illustrates an exemplary flow chart of a UE behavior for the UE to camp on both the macro cell and mmW small cell in accordance with embodiments of the current invention.

FIG. 9 illustrates an exemplary flow chart of a macro eNB behavior for the UE to camp on both the macro cell and mmW small cell in accordance with embodiments of the current invention.

FIG. 10 illustrates an exemplary flow chart of an mmW eNB behavior for the UE to camp on both the macro cell and mmW small cell in accordance with embodiments of the current invention.

### DETAILED DESCRIPTION

Reference will now be made in detail to some embodiments of the invention, examples of which are illustrated in the accompanying drawings.

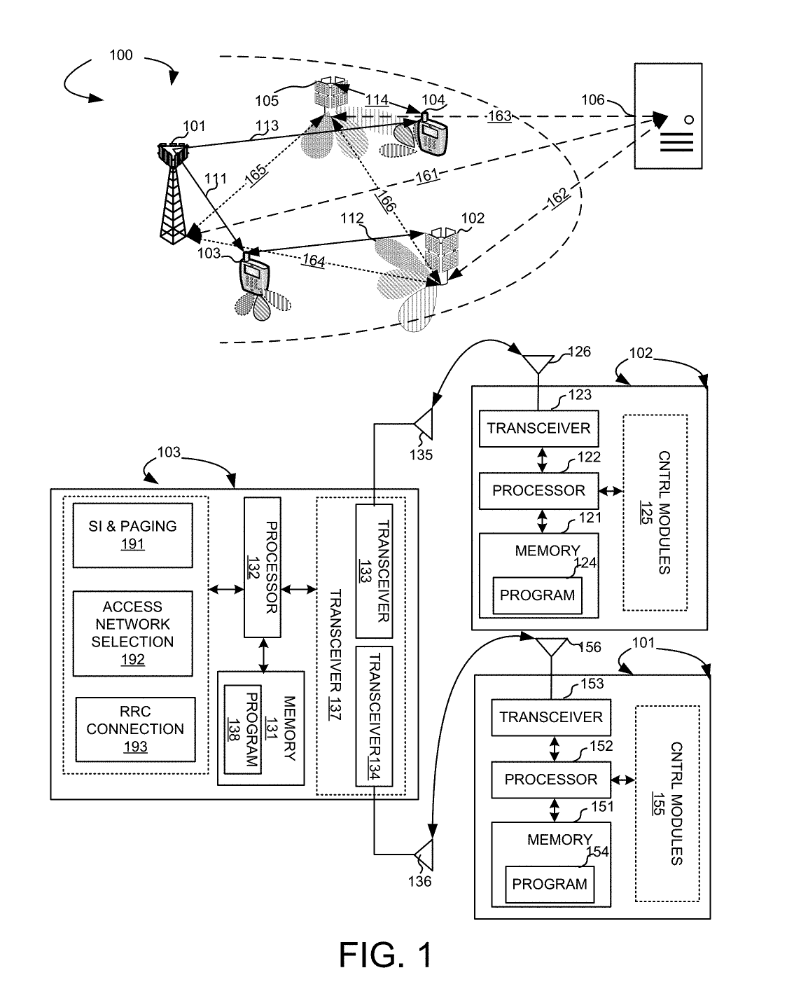

FIG. 1 illustrates an exemplary wireless communication network 100 in accordance with embodiments of the current invention. Wireless communication system 100 includes one or more fixed base infrastructure units, such as base stations 101, 102, and 105 forming a network distributed over a geographical region. The base unit may also be referred to as an access point, an access terminal, a base station, a Node-B, an eNode-B, or by other terminology used in the art. The one or more base stations 101, 102, and 105 serve a number of mobile stations 103 and 104 within a serving area, for example, a cell, or within a cell sector. In particularly, base stations 101 is a cellular base station covering a macro cell. Base stations 102 and 105 are millimeter wave (mmW) base stations overlapping the macro-cell coverage area. Backhaul connections 164, 165 and 166 connecting the non-co-located base stations 101, 102 and 105 can be either ideal or non-ideal. Base stations 101, 102 and 105 connect to a network entity, such as a mobility management entity (MME) 106 via links 161, 162, and 163, respectively. In some systems, one or more base stations are communicably coupled to a controller forming an access network that is communicably coupled to one or more core networks. The disclosure, however, is not intended to be limited to any particular wireless communication system.

eNB 101 is a conventional base station served as a macro eNB. eNB 102 and eNB 105 are mmW base stations, whose serving area partially or wholly overlap with the serving area of eNB 101, or does not overlap, as well as at least partially overlap with each other at the edge. mmW eNB 102 and mmW eNB 105 has multiple sectors each with multiple control beams to cover a directional area, wherein each control beam further comprises multiple dedicated beams in hierarchy. As an example, UE or mobile station 103 is in the service area of eNB 101 and mmW eNB 102. UE 103 connects with eNB 101 and eNB 102 via links 111 and 112, respectively. UE 104 is in the service area of eNB 101 and mmW eNB 105. UE 104 connects with eNB 101 and eNB 105 via links 113 and 114, respectively.

In one novel aspect, the UE camps on both the macro cell and the mmW small cell. In particular, UE 103 receives system information and paging messages from eNB 101 of the macro cell. UE 103 also acquires information of mmW small cells. In embodiment, the UE performs mmW cell discovery and measurement upon obtaining the mmW cell information in the system information from macro cell. In another embodiment, the UE determines conditions, such as the mobility status and the application type before performing the mmW cell discovery. The UE, though receives the paging message from the macro cell, establishes RRC connection via link 112 with the mmW cell and transfers data through the mmW base station 102.

FIG. 1 further shows simplified block diagrams of base stations 101, 102 and mobile station 103 in accordance with the current invention. Base station 101 has an antenna 156, which transmits and receives radio signals. A RF transceiver module 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in base station 101. Memory 151 stores program instructions and data 154 to control the operations of base station 101. Base station 101 also includes a set of control modules 155 that carry out functional tasks to communicate with mobile stations.

Similarly, base station 102 has an antenna 126, which transmits and receives radio signals, wherein the antenna 126 could be a antenna array used for beam forming of the mmW. A RF transceiver module 123, coupled with the antenna, receives RF signals from antenna 126, converts them to baseband signals, and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules 125 that carry out functional tasks to communicate with mobile stations.

Mobile station 103 has an antenna 135 and antenna 136, which transmits and receives radio signals. A RF transceiver module 137, coupled with the antennae, receives RF signals from antennae 135 and 136, converts them to baseband signals, and sends them to processor 132. RF transceiver 137 also converts received baseband signals from processor 132, converts them to RF signals, and sends out to antenna 136. Processor 132 processes the received baseband signals and invokes different functional modules to perform features in mobile station 103. Memory 131 stores program instructions and data 138 to control the operations of mobile station 103. Transceiver 137 of mobile station 103 includes two transceivers 133 and 134, and each transceiver could comprise one transmitter and one receiver (not shown). Transceiver 134 receives downlink transmissions from transceiver 153 of base station 101. Antenna 136 sends uplink transmission and receives downlink transmissions to/from antenna 156 of eNB 101. Antenna 135 sends uplink transmission and receives downlink transmissions to/from antenna 126 of eNB 102.

Mobile station 103 also includes a set of control modules that carry out functional tasks. A SI and paging module 191 receives SI and paging information from a macro eNB and obtains mmW small cell information. A access-network selection module 192 selects an access network based on the system information and the paging message. An RRC-connection module 193 establishes RRC connection with the selected access network.

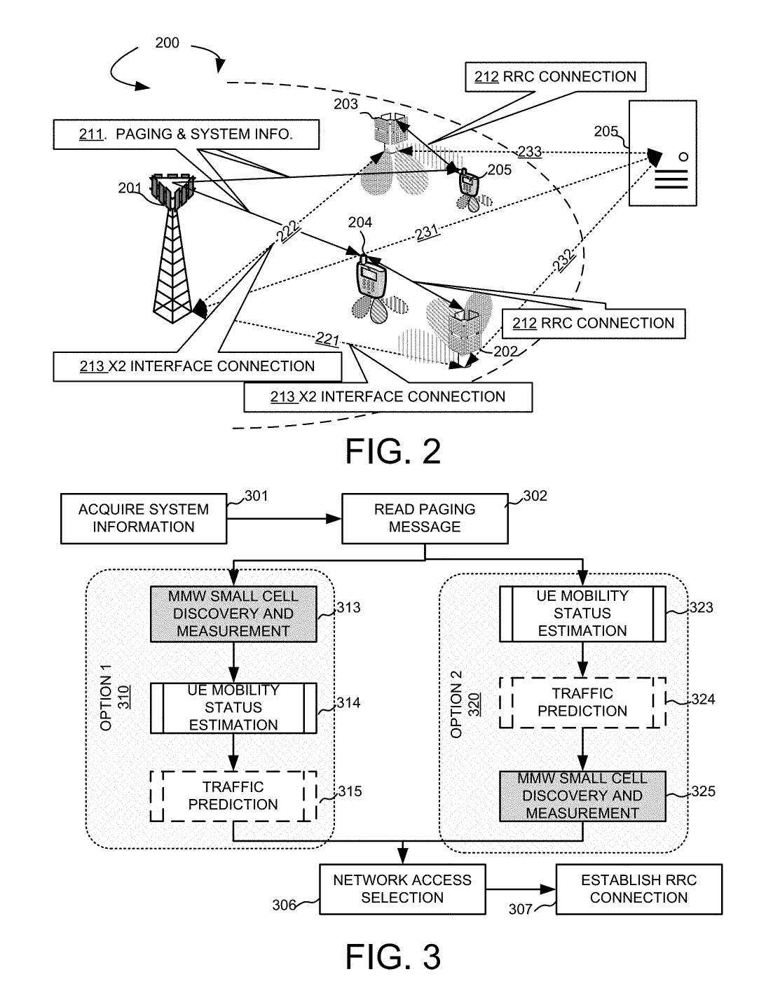

FIG. 2 shows an exemplary block diagram for the UEs to receive system information and paging messages from the macro eNB and establish RRC connection with the mmW base station in accordance with embodiments of the current invention. A heterogeneous wireless network 200 includes a conventional macro cell eNB 201 and mmW base stations 202 and 203, which have overlapped coverage area with eNB 201. eNBs 201, 202, and 203 connect with a network entity 205, such as a MME and a serving gateway (S-GW) through connections 231, 232 and 233, respectively. Backhaul connections, such as the X2 interface connections, connect non co-located base stations. eNBs 201, 202, and 203 are connected with each other through backhaul X2 interface connections 221, 222 and 223. eNBs exchanges information and signaling messages through the X2 interface connections. UEs 204 and 205 are in the coverage area of eNB 202 and eNB 203, respectively. Both UEs 204 and 205 are in the macro cell covered by eNB 101.

In one novel aspect, UEs 204 and 205 in idle mode, camp on both the conventional cellular macro cell and the mmW small cell. At steps 211, UEs 204 and 205 receives system information and paging messages from eNB 101. At steps 212, UEs 204 and 205 establishes RRC connections with mmW eNBs 202 and 203, respectively. At steps 213, eNBs 201 and 202, communicate through the X2 interfaces to exchange signal information to complete the connection, and the same for eNBs 201 and 203. Using the more reliable macro cell eNB 101 for system information and paging messages provides advantages over the method of camping on the mmW eNB only. It provides less signaling overhead from the network perspective, high-energy efficiency, high reliability, and retain-ability for the paging messages, and low power consumptions from the UE side. Further, for mobility UEs in the idle mode, camping on the macro cell reduces the cell (re)selection frequency and thus, further improves network efficiency and UE battery life.

UEs 204 and 205 receive the paging message from eNB 201, and establish RRC connections with the mmW base stations 202 and 203, respectively. By directly establishing RRC connections with the mmW base stations, the capacity of the mmW base stations, including the processors, memories and radio resources, can be fully utilized. The connections in ultra-density network (UDN) with extreme connection density can be offloaded efficiently to the mmW small cells. The bottleneck of backhaul connection between the macro eNB 101 and core network (CN) can be relieved. Processing of large amount of packets as well as the corresponding data forwarding over the X2 interface between the macro eNB and the large amount of mmW eNBs can be avoided.

FIG. 3 shows an exemplary flow chart of idle mode operation for mobile stations in the heterogeneous network in accordance with embodiments of the current invention. At step 301, the UE acquires system information from the macro eNB of the conventional cellular network. At step 302, the UE receives and reads the paging message from the macro eNB. Upon receiving the paging messages, there are two options, option-1 310, and option-2 320 to perform mmW cell discovery. In option-1 310, the UE always perform MMW small cell discovery and measurement if UE knows that there are MMW small cell deployed in the macro cell coverage. At step 313, the UE performs small cell discovery and measurement. At step 314, the UE performs mobility status estimation. Optionally, at step 315, the UE performs traffic prediction. Alternatively, upon receiving and reading the paging message from the macro eNB, the UE uses option-2 320. In option-2 320, the UE only performs MMW small cell discovery and measurement if it estimates that it is in low mobility status. At step 323, the UE estimates the mobility status of the UE. At step 324, optionally, the UE performs traffic prediction. At step 325, the UE performs small cell discovery and measurement if the UE is determined to be of stationary or of low mobility status. Optionally, the traffic type of the UE is also considered before the UE performs the mmW small cell discovery. After the mmW small discovery and measurement under both options, the UE moves to step 306 and performs the network access selection. If mmW small cell is available, based on UE mobility status and potentially the upcoming traffic, UE determines whether to perform the access through the macro cell or the mmW small cell. At step 307, the UE establishes the RRC connection with the selected access network.

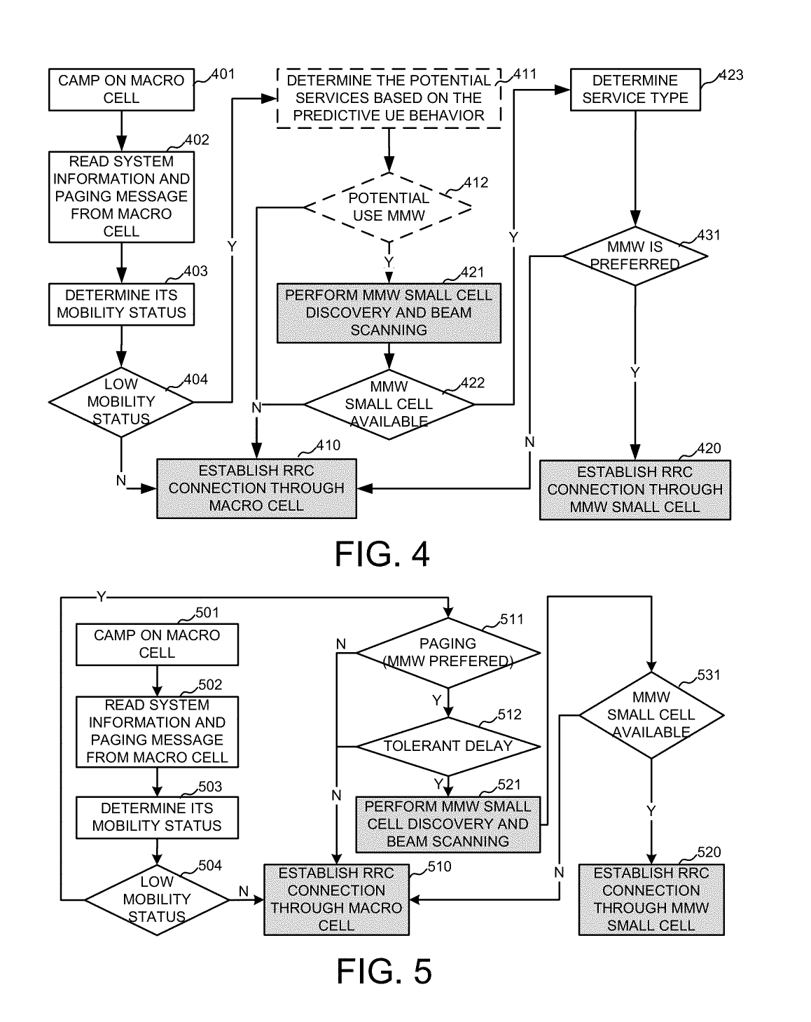

FIG. 4 illustrates an exemplary flow chart of the UE performing idle mode connection establishment in the heterogeneous network in accordance with embodiments of the current invention. At step 401, the UE camps on the macro cell. At step 402, the UE reads the system information and paging messages from the macro cell. In one embodiment, the system information from the macro cell includes mmW cell information. The mmW cell information includes: whether the macro cell can provide assistance to the mmW small cells, whether there are MMW small cells deployed under the coverage of the macro cell, the UE mobility level the mmW small cell can support though adaptive beamforming, assistance information for mmW small cell discovery and beam scanning such as the time relationship between each TTI and the swept azimuth (horizontal) and elevation (vertical) angles for each control beam. At step 403, the UE determines its mobility status. The mobility status can be determined by different means including using historical data and real time speed measurement. The UE then determines, at step 404, whether the UE is of low mobility status. The UE may determine that it is of low mobility status if the UE is stationary or its mobility is below a threshold. If step 404 determines that the UE not of the low mobility status, the UE moves to step 410 and establishes RRC connection with the macro cell. If the UE determines yes at step 404, the UE can move to perform mmW small cell discovery and measurement. Optionally, more conditions are checked. In one embodiment, the UE moves to step 411 to determine the potential services based on the predictive UE behavior. At step 412, the UE determines whether the mmW small cell would potentially be used based on the potential service. If step 412 determines no, the UE the UE moves to step 410 and establishes RRC connection with the macro cell. If step 412 determines yes, the UE moves to step 421 to perform the mmW small cell discovery and beam scanning. In one embodiment, UE can also perform the mmW small cell search and beam scanning based on the stored information. For example, the UE can use the footprint stored at the UE side. In another example, if the UE is stationary, the UE can begin mmW cell search from the cell where RRC connection was released or the UE was detached. After performing the mmW cell discovery and measurement, the UE moves to step 422 to determine if the mmW small cell is available. If step 422 determines no, the UE moves to step 410 and establishes RRC connection with the macro cell. If step 422 determines yes, in one embodiment, the UE can establish the RRC connection with the mmW small cell. Alternatively, further optimization can be done. Subsequently, the UE moves to step 423 to determine the service type. At step 431, the UE determines if mmW small cell is preferred for the service. If step 431 determines no, the UE moves to step 410 and establishes RRC connection with the macro cell. If step 431 determines yes, the UE moves to step 420 and establishes a RRC connection with the mmW small cell.

FIG. 5 illustrates an exemplary flow chart of the UE performing the MT call in the heterogeneous network in accordance with embodiments of the current invention. At step 501, the UE camps on the macro cell. At step 502, the UE reads the system information and paging messages from the macro cell. At step 503, the UE determines its mobility status. The mobility status can be determined by different means including using historical data and real time speed measurement. The UE then determines, at step 504, whether the UE is of low mobility status. The UE may determine that it is of low mobility status if the UE is stationary or its mobility is below a threshold. If step 504 determines that the UE not of the low mobility status, the UE moves to step 510 and establishes a RRC connection with the macro cell. In one embodiment, if the UE determines yes at step 504, the UE moves to step 511 to determine if the mmW small cell is preferred. In one embodiment, the preference of mmW small cell is indicated in the paging message received. If step 511 determines no, the UE moves to step 510 and establishes RRC connection with the macro cell. In one embodiment, further optimization is done if step 511 determines yes. The UE moves to step 512 and determines if the service is delay-tolerant. The UE can determine the latency for beam alignment and/or how quickly the beam synchronization between UE and eNB can be achieved. If step 512 determines no, the UE moves to step 510 and establishes RRC connection with the macro cell. If step 512 determines yes, the UE moves to 521 to perform the mmW small cell discovery and beam scanning. after step 512, the UE could read the system information from the discovered small cells. After performing the mmW cell discovery and measurement, the UE moves to step 531 to determine if the mmW small cell is available. If step 531 determines no, the UE moves to step 510 and establishes RRC connection with the macro cell. If step 531 determines yes, the UE moves to 520 to establish the RRC connection with the mmW small cell.

In one embodiment, the delay, which can be endured by the network, is indicated in the paging message. If there is no mmW small cell of good quality acquired within the time duration of the delay indicated in the paging message, UE establishes a RRC connection through the Macro cell. If the mmW small cell of good quality is acquired within the time duration of the delay indicated in the paging message, UE establishes a RRC connection through the mmW small cell. The UE needs to indicate to the small cell that the connection is for terminating call with paging received from the macro cell, together with the macro cell ID. In one embodiment, the indication is included in the RRCConnectionRequest message. In yet another embodiment, when there is only downlink (DL) traffic without uplink (UL) traffic (such as download from cloud), the UE may only perform MMW small cell discovery and measurement after paging message is received.

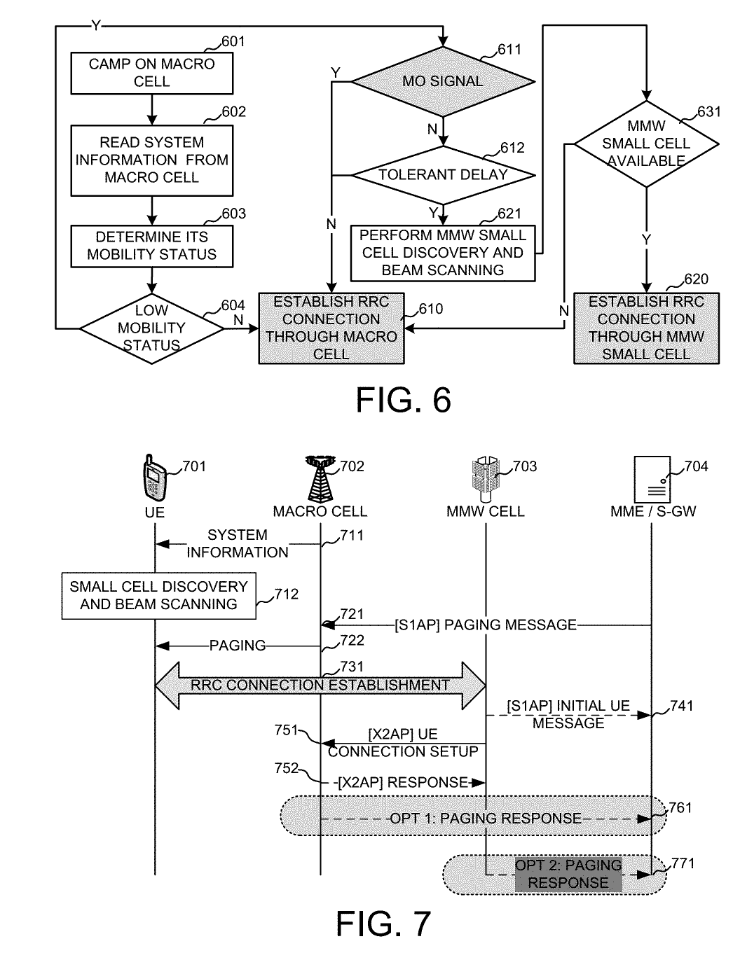

FIG. 6 illustrates an exemplary flow chart of the UE performing MO call in the heterogeneous network in accordance with embodiments of the current invention. At step 601, the UE camps on the macro cell. At step 602, the UE reads the system information and paging messages from the macro cell. At step 603, the UE determines its mobility status. The mobility status can be determined by different means including using historical data and real time speed measurement. The UE then determines, at step 604, whether the UE is of low mobility status. The UE may determine that it is of low mobility status if the UE is stationary or its mobility is below a threshold. If step 604 determines that the UE not of the low mobility status, the UE moves to step 610 and establishes RRC connection with the macro cell. In one embodiment, if the UE determines yes at step 604, the UE moves to step 611 to determine if it is mobile originated signaling connection. In one embodiment, if step 611 determines yes, the UE moves to step 610 and establishes RRC connection with the macro cell. In one embodiment, further optimization is done if step 611 determines no. The UE moves to step 612 and determines if the service is delay-tolerant. The UE can determine the latency for beam alignment and/or how quickly the beam synchronization between UE and eNB can be achieved. If step 612 determines no, the UE moves to step 610 and establishes RRC connection with the macro cell. In one embodiment, if step 612 determines yes, other characteristics of the services are considered, such as the UE application is of high data rate, and the UE application is of large volume, which all indicate a preference for the mmW small cell. If step 612 determines yes, the UE moves to 621 to perform the mmW small cell discovery and beam scanning, after step 621, the UE could read the system information from the discovered small cells. After performing the mmW cell discovery and measurement, the UE moves to step 631 to determine if the mmW small cell is available. If step 631 determines no, the UE moves to step 610 and establishes a RRC connection with the macro cell. If step 631 determines yes, the UE moves to 620 to establish the RRC connection with the mmW small cell.

It is advantageous for idle mode UE to camp on both the macro cell and the mmW small cell. The UE receives SI and paging messages from the macro cell while establishes RRC connections with the mmW small cells if certain conditions are met, such as the UE is of low mobility status. The network sides need modification to enable the UE to perform this operation. In transmitting a paging message to a UE, the MME can indicate whether the access to the network through the MMW small cells is preferred or not based on the upcoming services. The macro eNB may receive X2 message from the mmW base station that the RRC connection of the UE has been established, which is being paged by the macro base station. Subsequently, the macro eNB sends a response to the mmW base station acknowledging the reception of the RRC connection setup message. The macro eNB subsequently stops paging the UE. In one embodiment, the macro eNB may store the UE's context. In another embodiment, the macro eNB sends the paging response to MME.

Correspondingly, when the RRC connection is established with the UE, the mmW base station may forward UE context to the macro eNB for potential fallback due to the vulnerable radio condition of mmW frequency. If RRCconnectionrequest message received from the UE indicates that establishment cause is for terminating call with paging received from macro eNB, the MMW base station sends X2 message to the corresponding macro eNB indicating that RRC connection, which the macro cell is paging, has been established. The MMW base station subsequently receives response from the macro base station. In one embodiment, the MMW base station sends the paging response to MME.

FIG. 7 is an exemplary message diagram for the network to support the idle UE action in the heterogeneous network in accordance with embodiments of the current invention. A UE 701 camps on a macro cell served by a macro cell eNB 702. An mmW small cell served by an mmW eNB 703 serves overlapping area of the macro cell. UE 701 is also within the serving area of mmW eNB 703. eNB 702 and eNB 703 connect with a MME/S-GW 704. At step 711, UE 701 receives system information from macro cell eNB 702. The received system information includes mmW small cell information. At step 712, UE 701 performs small cell discovery and beam scanning based on the small cell information from the system information. At step 721, MME 704 sends the paging message to macro eNB 702, eg, through S1 interface. At step 722, macro eNB 702 transmits the paging message to UE 701. Upon detecting that UE 701 is paged, at step 731, UE 701 established a RRC connection with mmW eNB 703. At step 741, mmW eNB 703 sends an initial UE message to MME 704. In one embodiment, mmW eNB 703 sends a connection setup message to macro eNB 702 at step 751 through the X2 interface connection. In one embodiment, upon receiving this message, macro eNB 702 stops paging UE 701. At step 752, macro eNB 702 sends a response message to mmW eNB 703 through the X2 interface connection. In one embodiment, macro eNB 702 sends a paging response to MME 704 at step 761. In an alternative embodiment, mmW eNB 703 sends a paging response message to MME 704 at step 771.

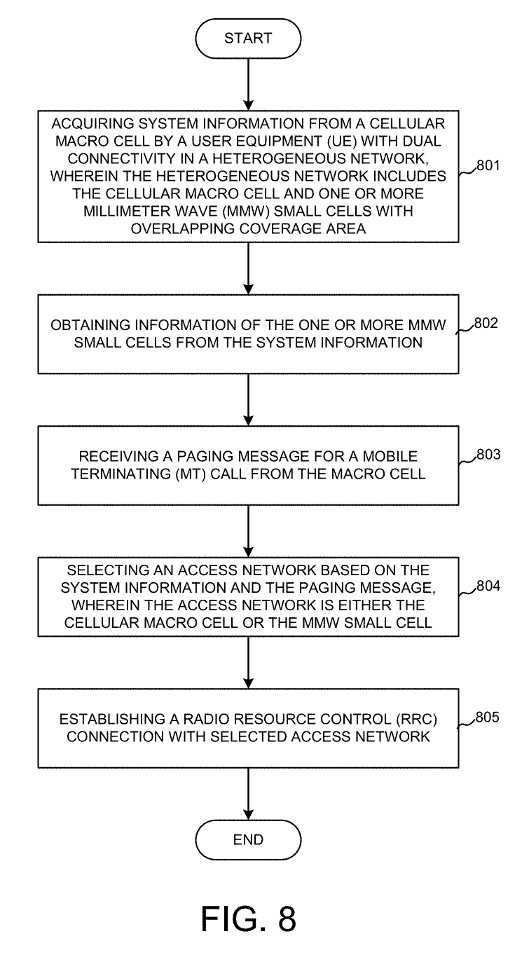

FIG. 8 illustrates an exemplary flow chart of a UE behavior for the UE to camp on both the macro cell and mmW small cell in accordance with embodiments of the current invention. At step 801, the UE acquires system information from a cellular macro in a heterogeneous network, wherein the heterogeneous network includes the cellular macro cell and one or more millimeter mmW small cells with overlapping coverage area. At step 802, the UE obtains information of the one or more mmW small cells from the system information. At step 803, the UE receives a paging message for a mobile terminating (MT) call from the macro cell. At step 804, the UE selects an access network based on the system information and the paging message, wherein the access network is either the cellular macro cell or the mmW small cell. At step 805, the UE establishes a radio resource control (RRC) connection with selected access network.

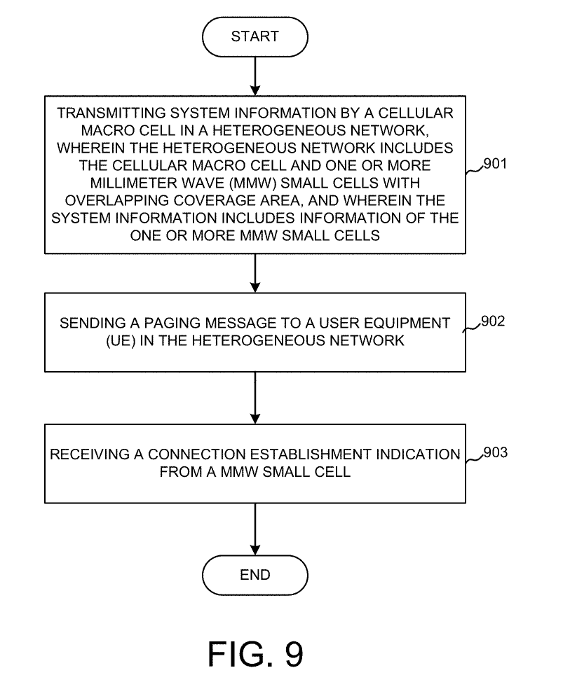

FIG. 9 illustrates an exemplary flow chart of a macro eNB behavior for the UE to camp on both the macro cell and mmW small cell in accordance with embodiments of the current invention. At step 901, the macro eNB transmits system information in a heterogeneous network, wherein the heterogeneous network includes the cellular macro cell and one or more mmW small cells with overlapping coverage area, and wherein the system information includes information of the one or more mmW small cells. At step 902, the macro eNB sends a paging message to a user equipment (UE) in the heterogeneous network. At step 903, the macro eNB receives a connection setup indication from an mmW small cell.

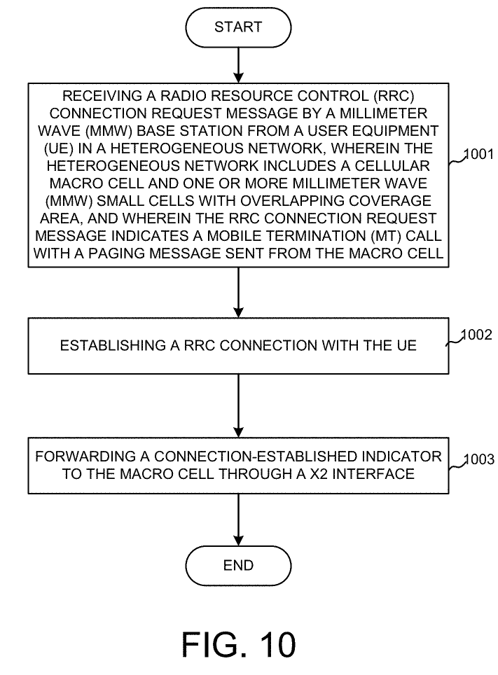

FIG. 10 illustrates an exemplary flow chart of an mmW eNB behavior for the UE to camp on both the macro cell and mmW small cell in accordance with embodiments of the current invention. At step 1001, the mmW eNB receives a RRC Connection Request message from a UE in a heterogeneous network, wherein the heterogeneous network includes the cellular macro cell and one or more mmW small cells with overlapping coverage area, and wherein the RRC Connection Request message indicates a mobile termination (MT) call with a paging message sent from the macro cell. At step 1002, the mmW eNB establishes a RRC connection with the UE. At step 1003, the mmW eNB forwards a connection-established indicator to the macro cell through an X2 interface.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
acquiring system information from a cellular macro cell by a user equipment (UE) in a heterogeneous network, wherein the heterogeneous network includes the cellular macro cell and one or more millimeter wave (mmW) small cells with overlapping coverage area;
receiving a paging message for a mobile terminating (MT) call from the macro cell;
selecting an access network based on the system information and the paging message, wherein the access network is either the cellular macro cell or the mmW small cell; and
establishing a radio resource control (RRC) connection with selected access network.

2. The method of claim 1 further comprising: performing an mmW cell selection and measurement when the system information indicates one or more mmW small cells exists in the coverage area.

3. The method of claim 1 further comprising:
determining a mobility status of the UE, wherein the mobile status indicates the moving speed of the UE; and
performing an mmW cell selection, beam scanning and measurement if the mobility status is determined to meet at least one low-mobility conditions comprising the UE being stationary, and the UE is of low mobility status.

4. The method of claim 1 further comprising:
determining an application traffic type of the UE; and
performing an mmW cell selection, beam scanning and measurement if the application traffic type is determined suitable for mmW small cell.

5. The method of claim 4, wherein the traffic type is suitable for mmW small cell if meets at least one of the conditions comprising: the traffic is delay tolerant, the UE application is of high data rate, and the UE application is of large volume.

6. The method of claim 1 further comprising: sending RRC Connection Request message to the selected mmW small cell and indicating the reception of the paging request message from the macro cell in the RRC Connection Request message.

7. The method of claim 1, wherein the system information comprises whether the macro cell provide assistance to the mmW small cell, whether there are mmW small cells deployed overlapping the macro cell coverage, a mobility level the mmW small cells can support, and assistance information for mmW small cell discovery and beam scanning.

8. The method of claim 1, wherein the paging message indicates whether accessing through mmW small cells is preferred.

9. The method of claim 1, wherein the selecting of the access network is further based on stored information of the UE, wherein the stored information comprises the footprint stored in the UE, and the cell information from which the UE was last released.

10. A method comprising:
transmitting system information by a cellular macro cell in a heterogeneous network, wherein the heterogeneous network includes the cellular macro cell and one or more millimeter wave (mmW) small cells with overlapping coverage area, and wherein the system information includes information of the one or more mmW small cells;
sending a paging message to a user equipment (UE) in the heterogeneous network; and
receiving a connection setup indication from a mmW small cell.

11. The method of claim 10, wherein the paging message indicates whether accessing through the mmW small cells is preferred.

12. The method of claim 10 further comprising: sending a connection-establishment response message to the mmW small cell.

13. The method of claim 10, further comprising: stopping paging the UE upon receiving the connection setup indication.

14. The method of claim 10 further comprising: sending paging response message to a mobility management entity (MME) upon receiving the connection setup indication.

15. The method claim 10, wherein the system information comprises: whether the macro cell provide assistance to the mmW small cell, whether there are mmW small cells deployed overlapping the macro cell coverage, a mobility level the mmW small cells can support, and assistance information for mmW small cell discovery and beam scanning.

16. A method, comprising:
receiving a radio resource control (RRC) Connection Request message by a millimeter wave (mmW) base station from a user equipment (UE) in a heterogeneous network, wherein the heterogeneous network includes a cellular macro cell and one or more millimeter wave (mmW) small cells with overlapping coverage area, and wherein the RRC Connection Request message indicates a mobile termination (MT) call with a paging message sent from the macro cell;
establishing a RRC connection with the UE; and
forwarding a connection-established indicator to the macro cell through an X2 interface.

17. The method of claim 16, further comprising: receiving a connection-establishment response message from the macro cell.

18. The method of claim 16, further comprising: sending a paging response message to a mobility management entity (MME) upon establishing the RRC connection with the UE.

19. The method of claim 16, further comprising: forwarding UE context to the macro cell for potential fallback.
